(19) United States
(12) Patent Application Publication
(10) Pub. No.: US 2005/0259945 A1
(43) Pub. Date: Nov. 24, 2005

(54) Method and system for automatic management of digital photography processing

(76) Inventor: Anthony Splaver, Camas, WA (US)

Correspondence Address: ANTHONY N. SPLAVER, 4607 NW ASPEN STREET, CAMAS, WA, 98607, US

(21) Appl. No.: 11/131,734

(22) Filed: May 18, 2005

Related U.S. Application Data
(60) Provisional application No. 60/572,676, filed on May 20, 2004.

(51) Int. Cl. H04N 9/74

(52) U.S. Cl. 386/4

(57) ABSTRACT

This invention describes a system and method for automatically managing digital photography processing. Users of digital cameras and other digital imaging devices must follow many manual steps to process the images. The manual processing steps include copying images from the camera or device to the disk drive on a computer, backing up the images, removing the images from the camera or device, printing thumbnail proof sheets, cataloging the images, editing the images, printing the images, and electronically distributing the images. Many of these processing steps require separate software applications, and require a significant amount of time to complete. This invention enables a single software application to automatically complete each of these steps, and provides the user with ease-of-use, image protection, editing, printing, image distribution, and the ability to quickly find images.

### CROSS-REFERENCE TO RELATED APPLICATIONS

This application claims the benefit of U.S. Provisional Patent Application No. 60/572,676 filed May 20, 2004 entitled “Method and System for Automatic Management of Digital Photography Processing” whose contents are incorporated herein for all purposes.

### BACKGROUND OF THE INVENTION

1. Field of the Invention

This invention relates to the tasks required to process digital photographs. More specifically, the invention relates to the software application to automate the processing of common tasks to help improve the organization, protection, printing, and distribution of digital photographs from digital cameras and other imaging devices in a single easy-to-use software photo processing application.

2. Description of the Related Art

Presently, there are a multitude of methods available to manage the processing of digital photography. The processing of digital photography involves moving images from a camera or digital imaging device to the disk drive of a computer, making a backup copy of the original images, removing the images from the camera or imaging device, printing thumbnail proof sheets, cataloging information about each image, editing images, printing images, and distributing images. The existing methods for processing digital photographs require a different computer software application to complete each step, and all of the processing requires manual intervention from the computer user.

The main problem with existing processing methods is that they require several separate computer applications to complete each step and there is a significant amount of manual intervention required from the computer user. The user must learn how to use each computer application, configure each application, and purchase each application. This method is time consuming, difficult to complete, and expensive. Prior systems fail to provide a single, easy-to-use, and automatic method for managing the processing of digital photographs.

There is a need to simplify the overall processing of digital photographs to provide the user with the ability to quickly and easily perform the diverse set of tasks required. There is a further need to automate this process.

### BRIEF SUMMARY OF THE INVENTION

This invention satisfies the above described needs by providing an improved system and method for managing digital photography processing steps. The invention provides a single system that performs all processing steps, the methods required to simplify the processing and improve the ease of use, and provides the ability to automate the entire process.

The object of this invention is to provide the user with the ability to automatically complete the steps required to process digital photographs with an easy-to-use interface from a single software application.

### BRIEF DESCRIPTION OF THE DRAWINGS

FIG. 1 is a block diagram of a computer that provides the environment for this invention.

FIG. 2 is a screen representation showing the presentation for the main screen of this invention.

FIG. 3 is a screen representation showing the presentation for the photo editor screen.

FIG. 4 is a screen representation showing the presentation for the catalog screen.

FIG. 5 is a flow diagram showing the high level steps for the automatic and manual features of this invention.

FIG. 6 is a flow diagram showing the steps for starting and initializing the system.

FIG. 7 is a flow diagram showing the steps for the downloading process.

FIG. 8 is a flow diagram showing the steps for the backup process.

FIG. 9 is a flow diagram showing the steps for the cleanup process.

FIG. 10 is a flow diagram showing the steps for the thumbnail printing process.

FIG. 11A is a flow diagram showing the steps for the initial catalog process.

FIG. 11B is a flow diagram showing the steps for the query catalog process.

FIG. 11C is a flow diagram showing the steps for the edit catalog information process.

FIG. 11D is a flow diagram showing the steps for the results action catalog process.

FIG. 11E is a flow diagram showing the steps for the edit list data catalog process.

FIG. 12A is a flow diagram showing the steps for the printing process.

FIG. 12B is a flow diagram showing the steps for the editing process.

FIG. 13 is a flow diagram showing the steps for the email process.

FIG. 14 is a flow diagram showing the steps for the web process.

FIG. 15 is a flow diagram showing the steps for configuration process.

FIG. 16 is a screen display showing the start screen.

FIG. 17 is a screen display showing the download screen.

FIG. 18 is a screen display showing the burn screen.

FIG. 19 is a screen display showing the cleanup screen.

FIG. 20 is a screen display showing the thumbnail screen.

FIG. 21 is a screen display showing the catalog screen.

FIG. 22 is a screen display showing the catalog viewer screen.

FIG. 23 is a screen display showing the print/edit screen.

FIG. 24 is a screen display showing the photo editor screen.

FIG. 25 is a screen display showing the email screen.

FIG. 26 is a screen display showing the web screen.

FIG. 27 is a screen display showing the configuration screen.

FIG. 28 is a screen display showing the formatting required for the HTML template file.

FIG. 29 is a screen display showing the HTML output web page.

### DETAILED DESCRIPTION OF THE INVENTION

This invention is designed to improve digital photography processing with automation and ease of use with a single computer software application. This invention is represented by the Splaver Software “PhotoSafe” computer software application. Briefly described, the software application uses intelligent default configurations and patterns established by the user to automate the digital photography processing steps of copying images from the camera or imaging device to the disk drive on a computer, backing up the images, removing the images from the camera or device, printing thumbnail proof sheets, cataloging the images, automatically editing the images to correct common photography issues, printing the images, and electronically distributing the images via email and the Internet.

When the typical digital camera user has taken enough pictures to fill the internal image recording media in the camera there are several steps that the user must compete to process the images before they can continue to take more pictures. The first step is to download the pictures from the camera or removable media to the disk drive on a computer. This step can be completed within the operating system or by using a downloading application for the camera. The user will typically perform a backup process to protect the master digital images. The backup process usually requires a separate software application to backup the images with a CD or DVD writing device. Then the user must remove the old images from the camera or media with the operating system or built-in features of the camera or imaging device. The user may decide to print a thumbnail proof sheet of the images to help visually find images in the future. To print the thumbnail proof sheets the user must use another software application. The user may decide to catalog the images to help organize and retrieve images in the future, which requires a database and another separate software application. The user will use another software application to edit the images (remove red eye, adjust the contrast and brightness, etc.) and print the images. Then the user may decide to manually distribute the images via email or the Internet using separate software applications. All of these steps must be completed manually and involve several software applications. The amount of time required to complete these digital photo processing steps is significant, requires manual intervention of the user, and requires the user to purchase, configure, and use multiple software applications. This invention provides a system and method for automatic management of digital photography processing within a single software application.

This invention teaches how to create a system that utilizes methods to automate the digital photography processing steps. The drawings illustrate the framework of this invention and are described below.

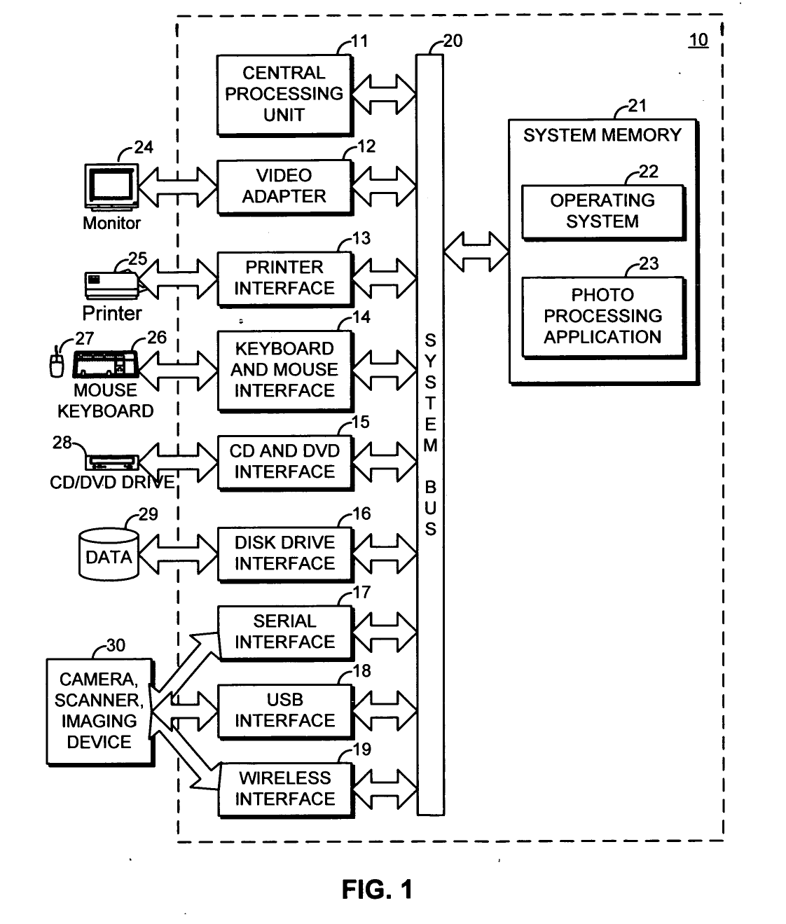

A personal computer 10 is shown in FIG. 1. The personal computer is comprised of many internal elements that operate together to provide general purpose computing features required to execute software applications. The personal computer 10 can be any type of computer, such as, Intel based computers, Macintosh, or SUN workstations. The personal computer 10 utilizes the central processing unit 11 and system memory 21 that are connected to the system bus 20. The system bus 20 is used to connect all of the internal devices together. The system memory 21 contains programs, like the operating system 22 to perform the basic system features for the personal computer. The system memory 21 contains specific software applications that are running in memory, like the photo processing application 23. The photo processing application 23 is the application that this invention concerns. The monitor 24 displays the output of the computer and is connected to the video adapter 12, which is connected to the system bus 20. The printer 25 creates hard-copy output and is connected to the printer interface 13, which is connected to the system bus 20. The mouse 27 and keyboard 26 are input devices that are connected to the keyboard and mouse interface 14, which is connected to the system bus 20. The CD and DVD drives 28 allow reading and writing to removable media and are connected to the CD and DVD interface 15, which is connected to the system bus 20. The digital camera, scanner, or other imaging device (like a palm computer, PDA, cell phone, etc.) 30 may be connected to the serial interface 17, USB interface 18, or wireless interface 19, which are connected to the system bus 20.

Those skilled in the art will understand the basic functionality and features of the personal computer 10. When the personal computer 10 is turned on, the operating system 22 is loaded to provide the framework for applications to run. The photo processing application 23 can be started manually by the user, or it can start automatically when the operating system detects that a digital camera, scanner, or imaging device 30 is connected to the personal computer. The monitor 24 is used to display the user interface for the application, the mouse 27 and keyboard 26 are used to gather input from the user, the printer 25 is used to print the photographs and thumbnail proof sheets, and the CD and/or DVD drive 28 are used to make backup copies of the digital photographs.

This invention can be implemented using a personal computer and a combination of software, firmware, and electronic circuits. The software program can be created with a high level programming language like Visual Basic or a lower level programming language like Visual C++. The programming language will create an executable program to provide the instructions to the personal computer to control this invention.

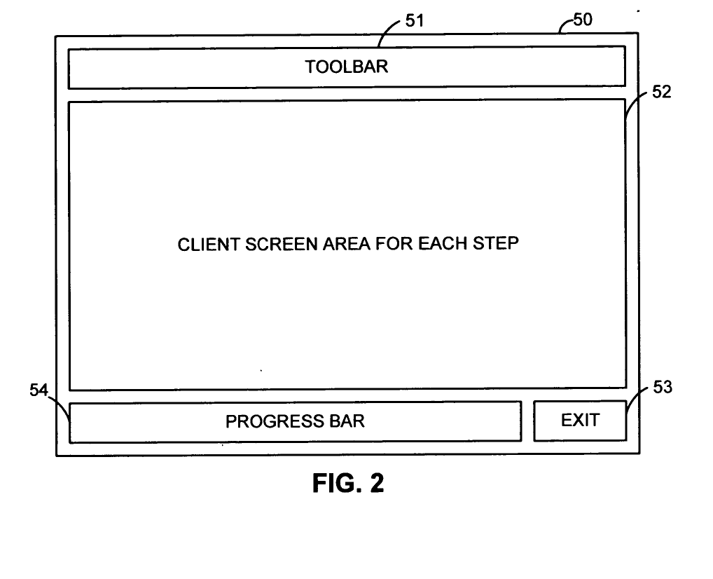

FIGS. 2-4 show the general framework for the user interface for this invention. FIG. 2 shows the application window 50 that contains the main user interface elements for this invention. The toolbar 51 is used to provide navigation between the photo processing steps. The client screen area 52 is the main area of the screen and provides the user interface elements for each step, and changes for each step. The progress bar 54 is used to provide feedback to the user during long processes. The exit button 53 is used to close the application.

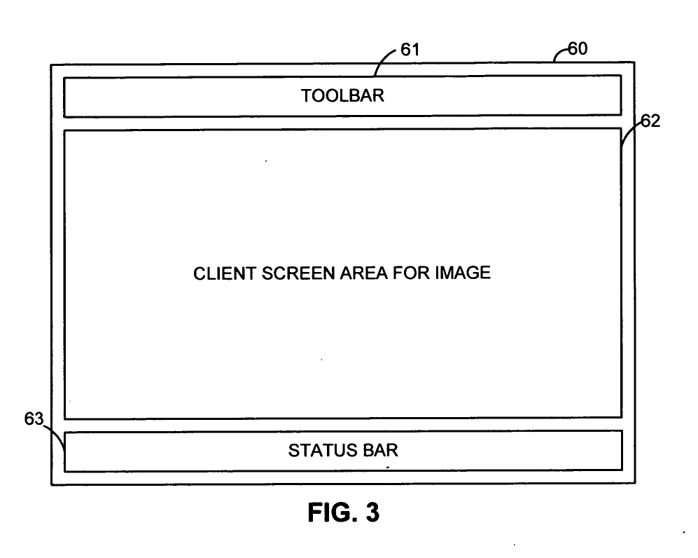

FIG. 3 shows the application window 60 for the digital photography editor. The toolbar 61 provides the quick and easy-to-use interface for editing photographs. The editor has features to edit the photographs like, contrast, exposure, brightness, red eye removal, color and white balancing, cropping, sharpness, and other photo effects. The client screen area for images 62 shows the photographs, and allows the user to zoom and pan the images. The status bar 63 shows information about the selected image like the filename, file date and time, file size, and photo dimensions.

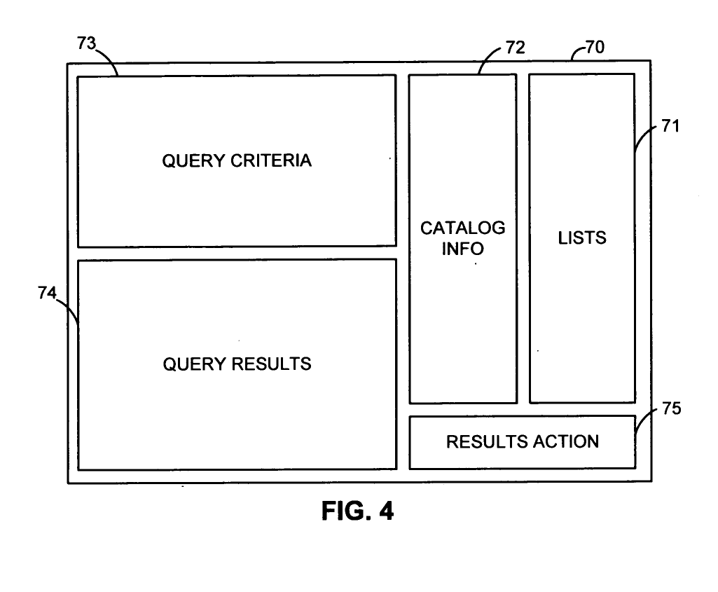

FIG. 4 shows catalog viewer screen 70 for this invention. The lists area 71 allows the user to edit, delete, and add new people and events to the database. The catalog info area 72 allows the user to assign descriptions, people, and events to specific images in the query results area 74. The query criteria area 73 is used to select the search criteria including the folders, people, events, descriptions, and date ranges. The user can easily and quickly create complex search criteria. The results of the query criteria are displayed in the query results area 74. The user can perform actions 75 on the results 74 including printing the photos, backing up the photos to a CD or DVD, sending the photos via email, creating a web page, or copying the photos to another folder on the disk drive.

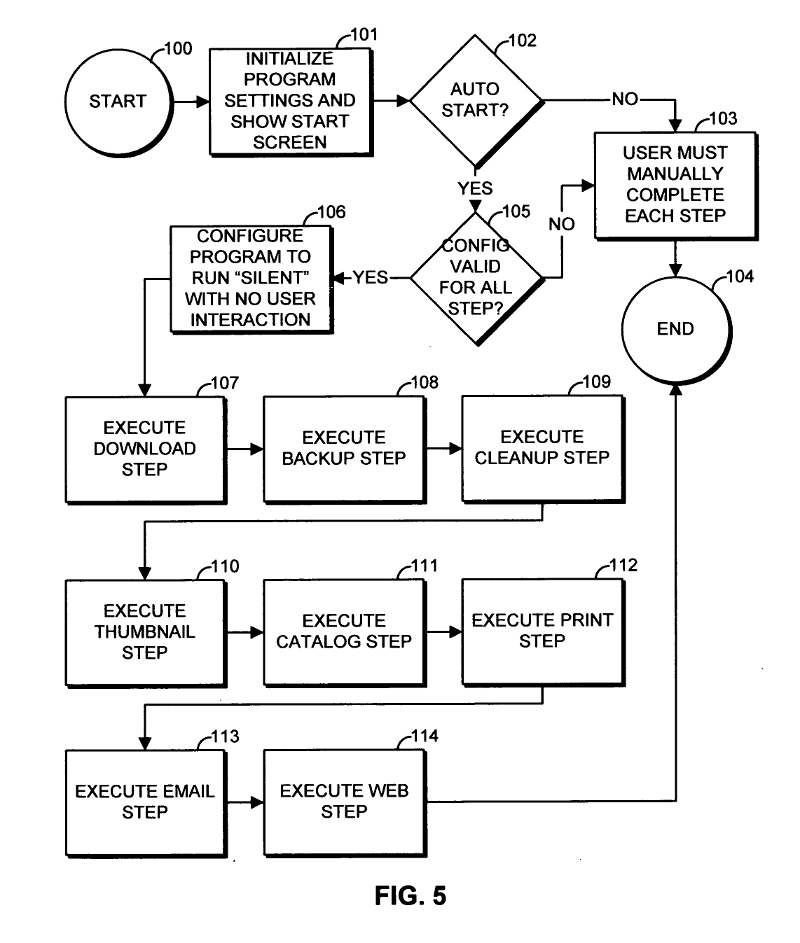

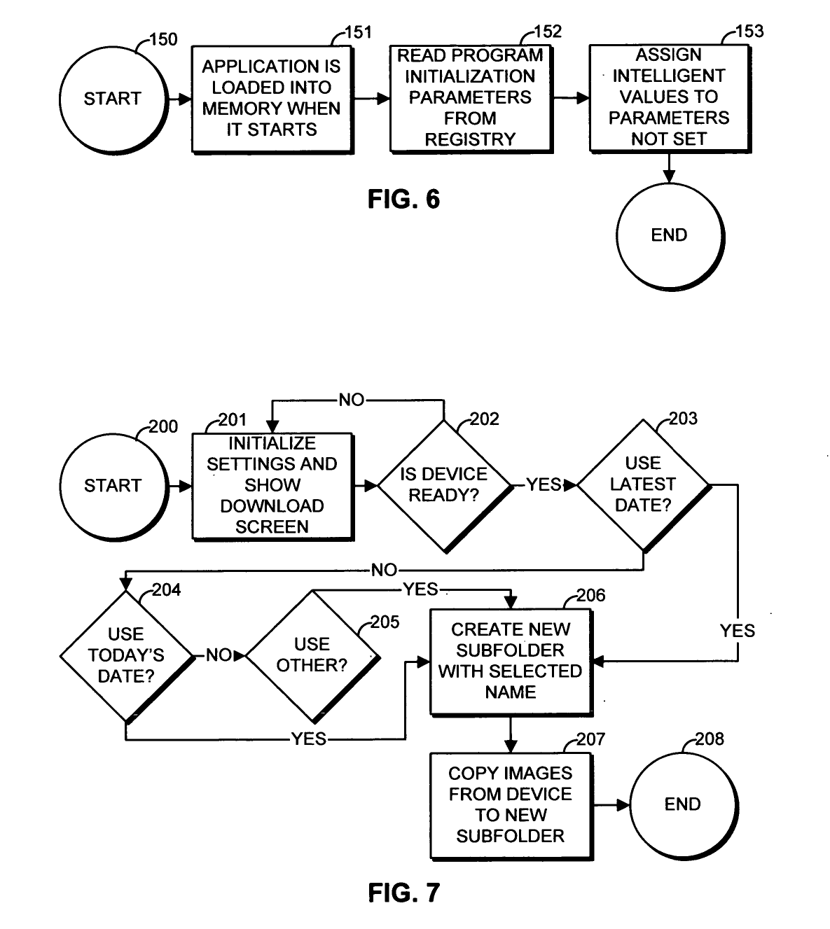

FIGS. 5-15 show the flow diagrams for this invention. FIG. 5 is the flow diagram for the automatic photo processing steps. The START step 100 represents the startup of the photo processing application 23 (FIG. 1). The user may perform the manual steps necessary to start the application in the operating system, or the application may automatically startup upon the detection of a digital camera or other imaging device being connected to the computer. In step 101 the application is initialized and intelligent defaults are selected for options that the user has not already configured, and the startup screen is displayed. The application determines if it is configured to automatically start the photo processing in step 102. The “YES” branch is followed to step 105 if the system is configured to automatically start, otherwise the “NO” branch is followed to step 103. The user can manually execute each step of the photo processing in step 103, and the user can exit the application in step 104 when they are complete. Step 105 verifies that all of the required configuration data is valid to perform automatic processing. The “YES” branch is followed to step 106 if the configuration is valid, otherwise the “NO” branch is followed to step 103 to allow the user to manually configure and execute the processing steps. The application is setup to execute in “SILENT” mode in step 106, which mean the application will execute all of the photo processing steps with no user interaction required. The automatic photo processing steps include copying images from the camera or device to the disk drive on a computer, backing up the images, removing the images from the camera or device, printing thumbnail proof sheets, cataloging the images, automatically editing the images to correct common photography issues, printing the images, and electronically distributing the images via email and the Internet. These steps are illustrated in steps 107-114. The automatic photo processing in steps 107-114 are described in more detail in FIGS. 6-14. When the automatic processing of the photos is completed the application exits in step 104.

FIG. 6 shows the flow diagram for the initialization and startup process for this invention. This flow diagram shows the details for step 101 (FIG. 5). The START step 150 represents the startup of the photo processing application 23 (FIG. 1). The user may manually perform the steps necessary to start the application in the operating system, or the application may automatically startup upon the detection of a digital camera or other imaging device being connected to the computer. The photo processing application 23 is loaded into system memory 21 (FIG. 1) in step 151, and the startup screen is displayed on the monitor 24 (FIG. 1). The application reads the initialization parameters from a local repository, like the Registry in the Microsoft Windows operating system, in step 152. The parameters that have not already been set by the user will be assigned intelligent defaults in step 153. Examples of these parameters include the location of the images on the camera to download, the destination location on the personal computer to download the images, the CD or DVD burner information, printing options, distribution options, and other basic configuration settings. The application will continue execution in the END step by following step 102 in FIG. 5.

FIG. 7 shows the flow diagram for the downloading process. The first step that must occur before starting the digital photo processing on a computer is to download the images from the digital camera, removable media of the camera, scanner, or other imaging device. Step 200 is the starting point for downloading the images, and it can happen when the user manually selects this step in the application or automatically when the automatic photo processing executes this in step 107 of FIG. 5. Step 201 initializes the settings for this step, and utilizes intelligent default values from step 153 of FIG. 6 if necessary. The application then checks to see if the device is connected and ready for downloading in step 202. If the device is ready, then the “YES” branch is followed to step 203, otherwise the “NO” branch is followed back to step 201 for retries. Steps 203, 204 and 205 determine the download folder naming convention. The USE LATEST DATE option is checked first in step 203, and if selected the “YES” branch is followed to step 206, otherwise the “NO” branch is followed to step 204. The USE TODY'S DATE option is checked in step 204, and if selected the “YES” branch is followed to step 206, otherwise the “NO” branch is followed to step 205. The OTHER option is checked in step 205, and if selected the “YES” branch is followed to step 206, otherwise the default of USE LAST DATE is selected and goes to step 206. The folder naming convention allows the user to select the name of the subfolder. For example, if the user selects USE LATEST DATE the subfolder name will have the date of the last picture that is downloaded, the USE TODAY'S DATE option will have a name equal to today's date, and the OTHER option allows the user to enter any folder name. A subfolder is created on the disk drive under the established base folder in step 206 using the selected download folder naming convention from steps 203, 204, and 205. All of the images are copied from the device to the new subfolder in step 207. The processing will automatically continue to step 108 in FIG. 5 if automatic processing was selected, otherwise processing will manually continue to step 103 in FIG. 5.

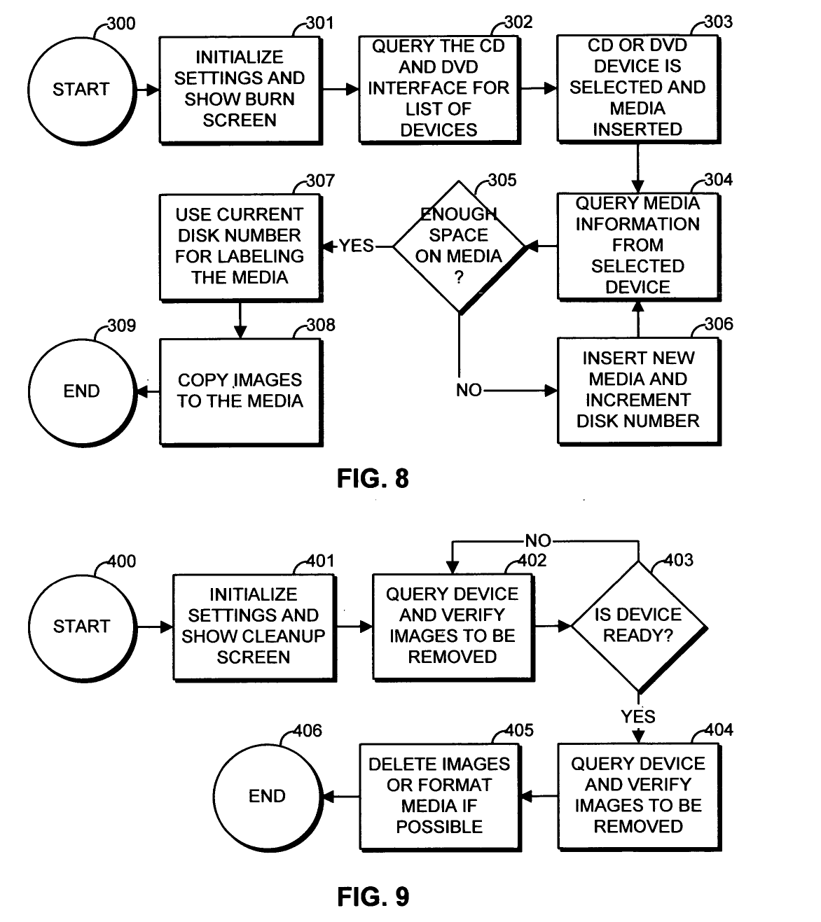

FIG. 8 shows the flow diagram for the image backup process. Step 300 is the starting point for backing up the images, and it can happen when the user manually selects this step or automatically when the automatic photo processing executes this in step 108 of FIG. 5. Step 301 initializes the settings for this step, and utilizes intelligent default values from FIG. 6 if necessary. The CD and DVD interface 15 (FIG. 1) is queried in step 302 to obtain a list of CD and DVD writing devices. The user can manually select the device from the list if running in manual mode or the device is selected automatically in step 303, and the user must insert blank or multi-session media into the CD or DVD drive 28 (FIG. 1). The CD and DVD interface 15 (FIG. 1) is queried in step 304 to determine the available space on the media. The available space on the selected media is compared to the space required for the current backup session in step 305. If there is enough space, then the “YES” branch is followed to step 307, otherwise the “NO” branch is followed to step 306. The user is prompted to insert blank media into the CD or DVD drive in step 306, and the automatic disk numbering logic increments the disk number. For example, if the user has selected the media label to be “Photos” and the current disk number is 7, then the media label for the next disk will be set to “Photos8” in step 306. The current disk number is appended to the base media label in step 307, and is used when burning the images to identify the media. The images are backed up to the CD or DVD media in step 308. The processing will automatically continue to step 109 in FIG. 5 if automatic processing was selected, otherwise processing will manually continue to step 103 in FIG. 5.

FIG. 9 shows the flow diagram for the cleanup process. Step 400 is the starting point for cleaning up the images, and it can happen when the user manually selects this step or automatically when the automatic photo processing executes this in step 109 of FIG. 5. Step 401 initializes the settings for this step, and utilizes intelligent default values from FIG. 6 if necessary. The serial, USB, or wireless interfaces 17, 18, and 19 (FIG. 1) are queried in step 402 to verify that the images can be removed. The application then checks to see if the device is connected and ready to remove the images in step 403. If the device is ready, then the “YES” branch is followed to step 404, otherwise the “NO” branch is followed to step 402 for retries. The device is queried again in step 404 and the device is locked to prevent other applications from making file system changes. The images are deleted or the media is formatted if possible in step 405. The processing will automatically continue to step 110 in FIG. 5 if automatic processing was selected, otherwise processing will manually continue to step 103 in FIG. 5.

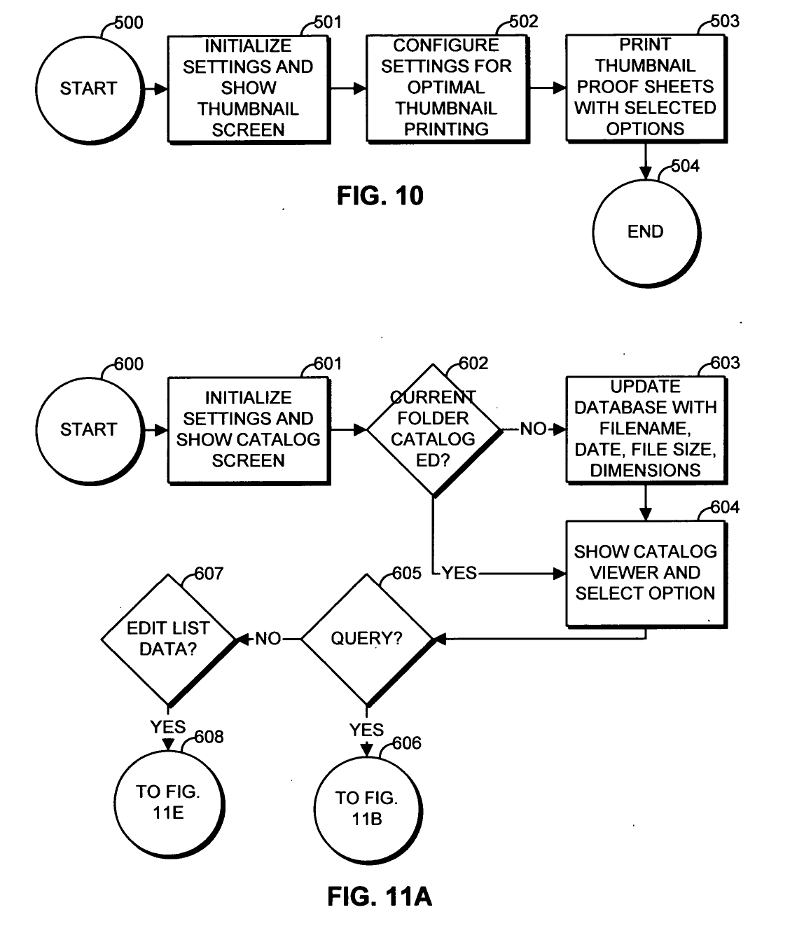

FIG. 10 shows the flow diagram for the thumbnail printing process. Step 500 is the starting point for thumbnail printing, and it can happen when the user manually selects this step or automatically when the automatic photo processing executes this in step 110 of FIG. 5. Step 501 initializes the settings for this step, and utilizes intelligent default values from FIG. 6 if necessary. All of the photo images are analyzed to determine the best settings for printing the thumbnail proof sheets in step 502. These settings include the quality of the thumbnail, the size of the thumbnail images, printing orientation, number of images to print across and down the page, and other printing parameters. The thumbnail proof sheets are printed in step 503. The printed sheets can have the images sorted by date or filename, filenames and dates printed below the images, and header information, including the folder name, page numbers, and date range for the images are printed at the top of each page. The processing will automatically continue to step 111 in FIG. 5 if automatic processing was selected, otherwise processing will manually continue to step 103 in FIG. 5.

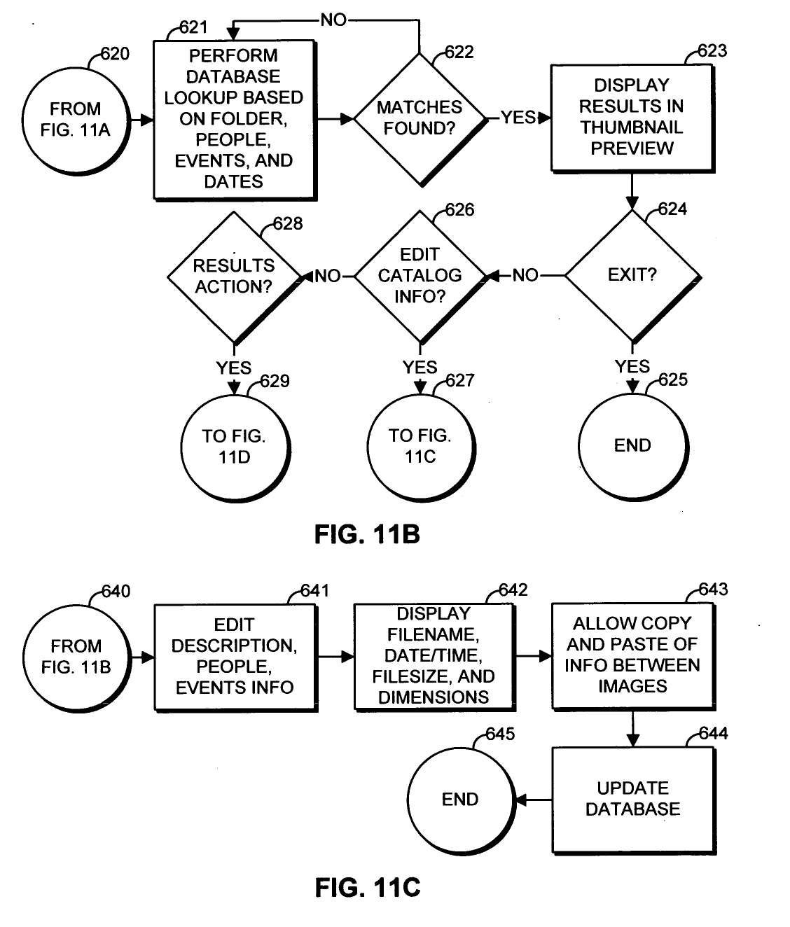

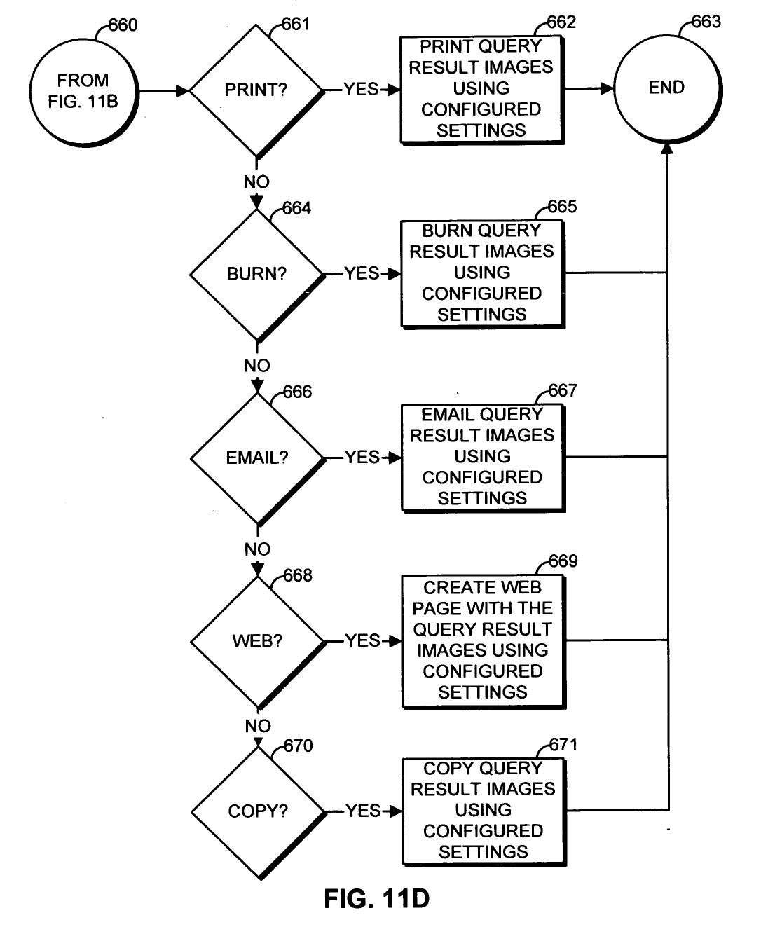

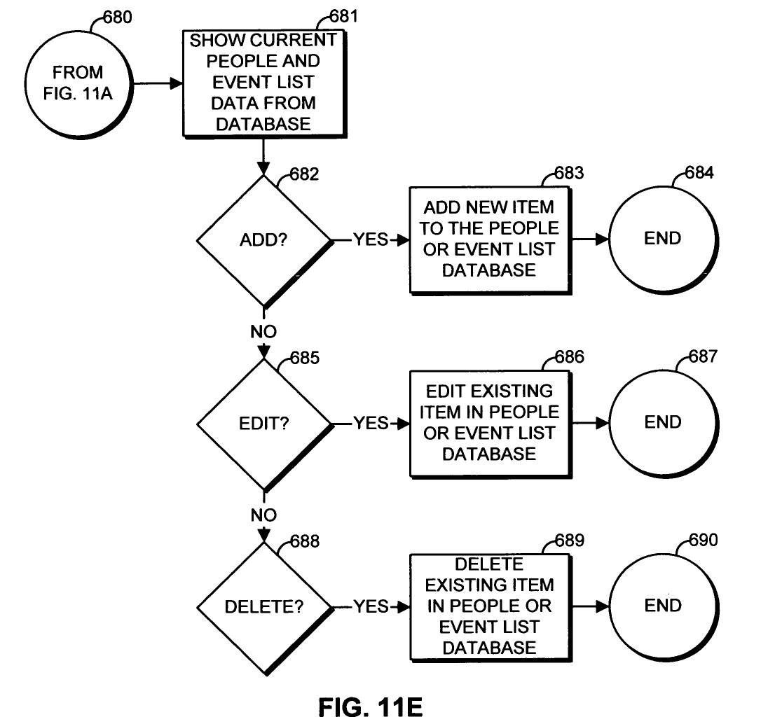

FIG. 11A shows the flow diagram for the photo cataloging process. Step 600 is the starting point for photo cataloging, and it can happen when the user manually selects this step or automatically when the automatic photo processing executes this in step 111 of FIG. 5. Step 601 initializes the settings for this step, and utilizes intelligent default values from FIG. 6 if necessary. The application checks the catalog database to determine if the current folder is cataloged in step 602. If the current folder is already cataloged, then the “YES” branch is followed to step 604, otherwise the “NO” branch is followed to step 603. The catalog database is updated with the filename, folder location, date, time, file size, dimensions, and other photo properties for each photo image in the catalog folder in step 603. The catalog viewer window 70 (FIG. 4) is displayed in step 604 to allow the user to select a catalog option. If the user selects the query option in step 605, then the “YES” branch is followed to step 606, otherwise the “NO” branch is followed to step 607. If the user selects the edit list data option in step 607, then the “YES” branch is followed to step 608, otherwise the processing will automatically continue to step 112 in FIG. 5 if automatic processing was selected, otherwise processing will manually continue to step 103 in FIG. 5.

FIG. 11B shows the flow diagram for the catalog query process. The query process starts in step 620. The database is queried in step 621 with the search criteria established by the user in 73 (FIG. 4), and the criteria can include the folder, people, events, dates, and descriptions. By default the criteria will find all images in the current folder. If matches are found in the database in step 622, then the “YES” branch is followed to step 623, otherwise the “NO” branch is followed to step 621 to retry the query. The results of the query are displayed in the thumbnail preview in the query results area 74 (FIG. 4) in step 623, which displays all of the images that match the selected criteria in a two dimensional array of thumbnails. If the user decides to exit in step 624, then the “YES” branch is followed to step 625, otherwise the “NO” branch is followed to step 626. In step 625, the processing will automatically continue to step 112 in FIG. 5 if automatic processing was selected, otherwise processing will manually continue to step 103 in FIG. 5. If the user decides to edit the catalog information for a specific image in step 626, then the “YES” branch is followed to step 627, otherwise the “NO” branch is followed to step 628. If the user decides to perform an action on the results in step 628, then the “YES” branch is followed to step 629, otherwise the processing will automatically continue to step 112 in FIG. 5 if automatic processing was selected, otherwise processing will manually continue to step 103 in FIG. 5.

FIG. 11C shows the flow diagram for the editing of catalog information process. The process starts in step 640. The user can edit the description and assign people and events to each photograph image in the catalog info area 72 (FIG. 4) in step 641. Additional information is displayed for each image in step 642, including the filename, date, time, file size, and dimensions. The user can quickly copy the description and the assigned lists of people and events between multiple images in step 643. The catalog database is updated in step 644. The processing will automatically continue to step 112 in FIG. 5 if automatic processing was selected, otherwise processing will manually continue to step 103 in FIG. 5.

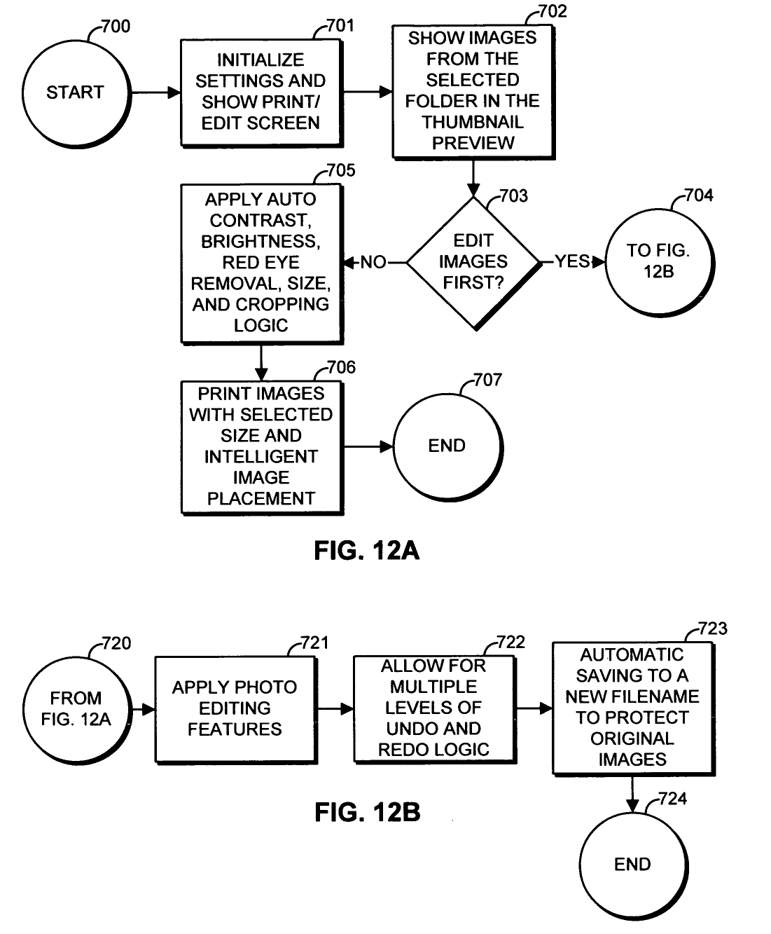

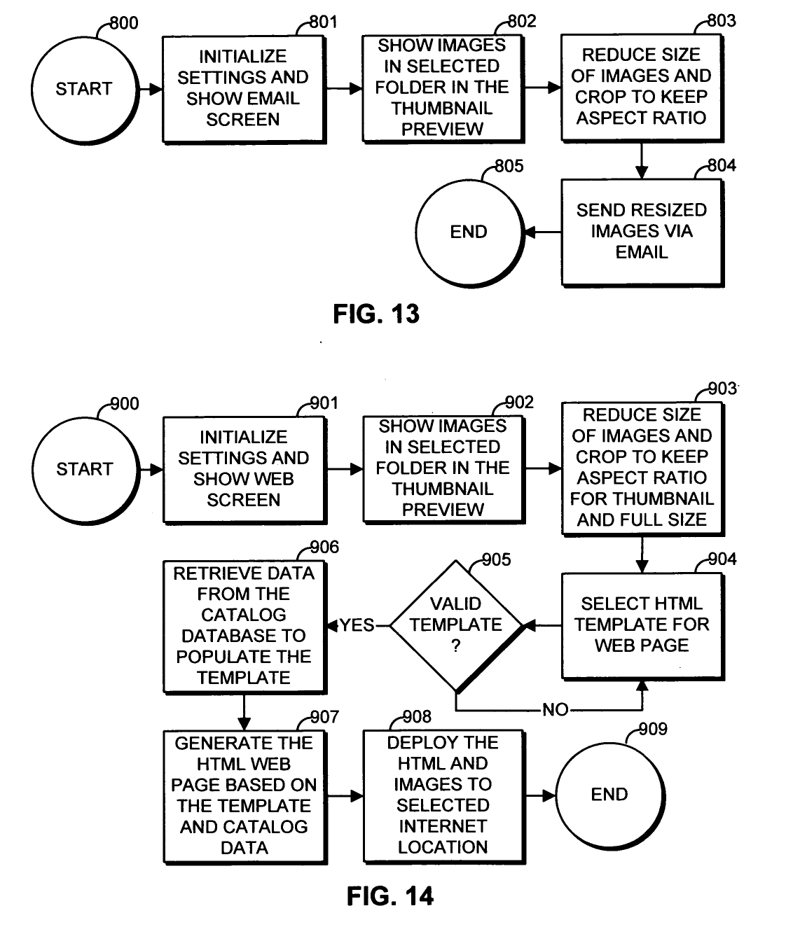

FIG. 11D shows the flow diagram for the results action process. The process starts in step 660. The user can select specific actions to perform on the results of a query in the results action area 75 (FIG. 4), including printing, backing up, emailing, Internet distribution, and copying to new folders on the disk drive. If the user selects the print action in step 661, then the “YES” branch is followed to step 662 where the selected images are printed in a similar way shown in FIG. 12A, otherwise the “NO” branch is followed to step 664. If the user selects the burn action in step 664, then the “YES” branch is followed to step 665 where the selected images are copied to a CD or DVD in a similar way shown in FIG. 8, otherwise the “NO” branch is followed to step 666. If the user selects the email action in step 666, then the “YES” branch is followed to step 667 where the selected images are distributed via email in a similar way shown in FIG. 13, otherwise the “NO” branch is followed to step 668. If the user selects the web action in step 668, then the “YES” branch is followed to step 669 where the selected images are distributed via the Internet in a similar way shown in FIG. 14, otherwise the “NO” branch is followed to step 670. If the user selects the copy action in step 670, then the “YES” branch is followed to step 671 where the selected images are copied to the specified destination folder on the disk drive, otherwise in step 663 the processing will automatically continue to step 112 in FIG. 5 if automatic processing was selected, otherwise processing will manually continue to step 103 in FIG. 5.

FIG. 11E shows the flow diagram for the editing of the people and event lists process. The process starts in step 680. The user must create the list of people and events that they want to assign to specific photos in this process. Examples of people are “Mom”, “Dad”, or “Joe”, and examples of events are “Christmas”, “Birthday”, or “Vacation”. The list of people and events are displayed to the user in step 681. The user can select options to add new items to each list, edit items in the lists, or delete items from the lists in the lists area 71 (FIG. 4). If the user selects to add an item in step 682, then the “YES” branch is followed to step 683 where the new item is stored in the database and execution continues to step 684, otherwise the “NO” branch is followed to step 685. If the user selects to edit an existing item in step 685, then the “YES” branch is followed to step 686 where changes to the item are stored in the database and execution continues to step 687, otherwise the “NO” branch is followed to step 688. If the user selects to delete an existing item in step 688, then the “YES” branch is followed to step 689 where the item is deleted from the database and execution continues to step 690, otherwise the processing will automatically continue to step 112 in FIG. 5 if automatic processing was selected, otherwise processing will manually continue to step 103 in FIG. 5.

FIG. 12A shows the flow diagram for the printing and editing process. Step 700 is the starting point for printing and editing, and it can happen when the user manually selects this step or automatically when the automatic photo processing executes this in step 112 of FIG. 5. Step 701 initializes the settings for this step, and utilizes intelligent default values from FIG. 6 if necessary. The images for the selected folder are displayed in a thumbnail preview in step 702. The user can edit the images first in step 703. If the user edits the images, then the “YES” branch is followed to step 704, otherwise the “NO” branch is followed to step 705. Automatic photo processing is applied in step 705 to provide the highest quality printed images by applying automatic adjustments for contrast, brightness, red eye removal, sizing, cropping, and other image processing features. The selected images are printed on the photo quality printer 25 (FIG. 1) in step 706. The processing will automatically continue to step 113 in FIG. 5 if automatic processing was selected, otherwise processing will manually continue to step 103 in FIG. 5.

FIG. 12B shows the flow diagram for the photo editing process. Step 720 is the starting point for editing. The user can apply many photo editing features including contrast, exposure, brightness, red eye removal, color and white balancing, cropping, sharpness, and other photo effects in the photo editor screen 60 (FIG. 3) in step 721. The application allows multiple levels of undo and redo logic to allow the user to quickly undo changes made to the image without having to reload the image in step 722. The master image is automatically protected during the saving step, because the application automatically saves the file with a different filename in step 723. The processing will automatically continue to step 113 in FIG. 5 if automatic processing was selected, otherwise processing will manually continue to step 103 in FIG. 5.

FIG. 13 shows the flow diagram for the email process. Step 800 is the starting point for emailing, and it can happen when the user manually selects this step or automatically when the automatic photo processing executes this in step 113 of FIG. 5. Step 801 initializes the settings for this step, and utilizes intelligent default values from FIG. 6 if necessary. The images for the selected folder are displayed in a thumbnail preview in step 802. The dimensions of the selected images are reduced in size, the images are resized and/or cropped, and the aspect ratio is maintained in step 803. The reduced images are sent to one or multiple email recipients in step 804. The processing will automatically continue to step 114 in FIG. 5 if automatic processing was selected, otherwise processing will manually continue to step 103 in FIG. 5.

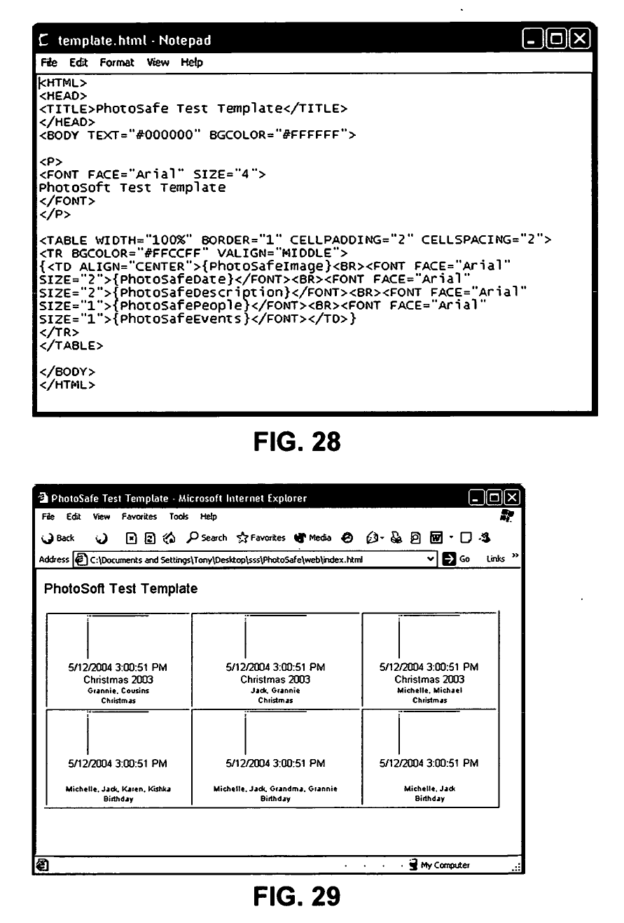

FIG. 14 shows the flow diagram for the web distribution process. Step 900 is the starting point for this process, and it can happen when the user manually selects this step or automatically when the automatic photo processing executes this in step 114 of FIG. 5. Step 901 initializes the settings for this step, and utilizes intelligent default values from FIG. 6 if necessary. The images for the selected folder are displayed in a thumbnail preview in step 902. The dimensions of the selected images are reduced in size, the images are resized and/or cropped, and the aspect ratio is maintained in step 903 for both a thumbnail size and full size to be displayed in the completed HTML web page. The HTML template (FIG. 28) is selected in step 904. If the template is valid and contains the correct formatting and catalog field information in step 905, then the “YES” branch is followed to step 906, otherwise the “NO” branch is followed back to step 904 to retry. The data for each image is retrieved from the catalog database in step 906, and the HTML web page (FIG. 29) is generated in step 907. The completed HTML web page contains a table with the thumbnail images, links from each thumbnail image to a full sized image, and catalog information about the image including the description, date, time, people list, event list, and file size. The web page and images are deployed to the Internet in step 908. The processing will automatically stop in step 909 if automatic processing was selected, otherwise processing will manually continue to step 103 in FIG. 5.

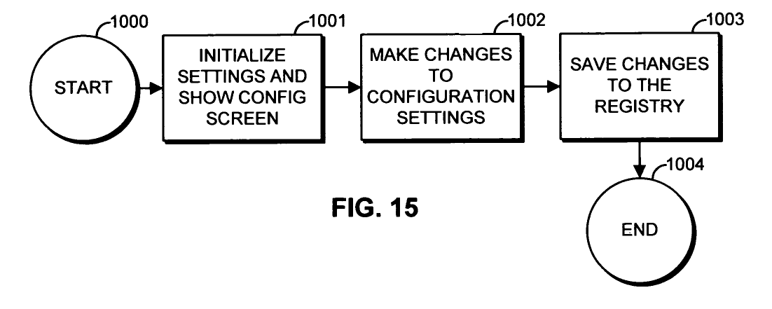

FIG. 15 shows the flow diagram for the configuration process. Step 1000 is the starting point for this process, and it happens when the user manually selects this step. Step 1001 initializes the settings for this step, and utilizes intelligent default values from FIG. 6 if necessary. The user makes changes to the configuration settings in step 1002, and the changes are saved to a centralize repository, like the Windows Registry, in step 1003.

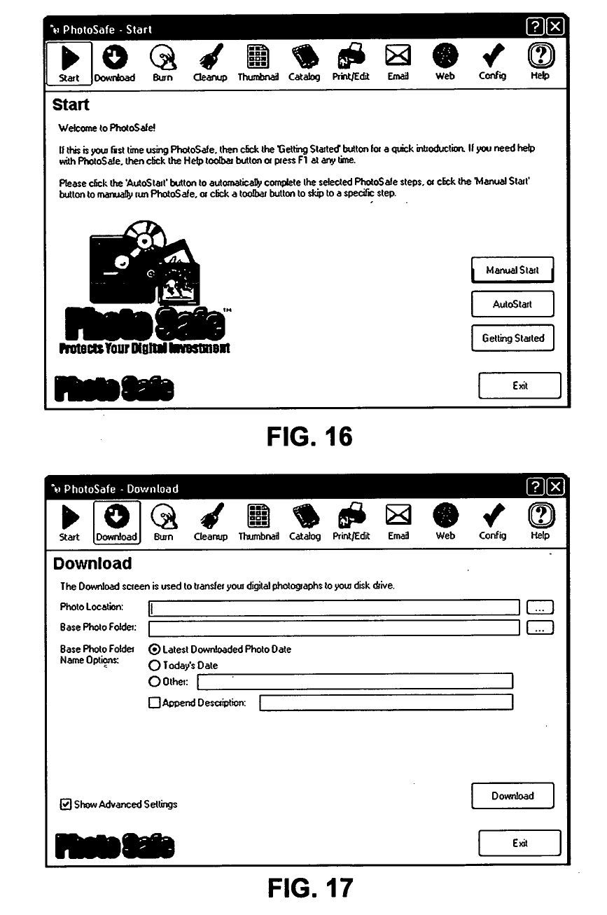

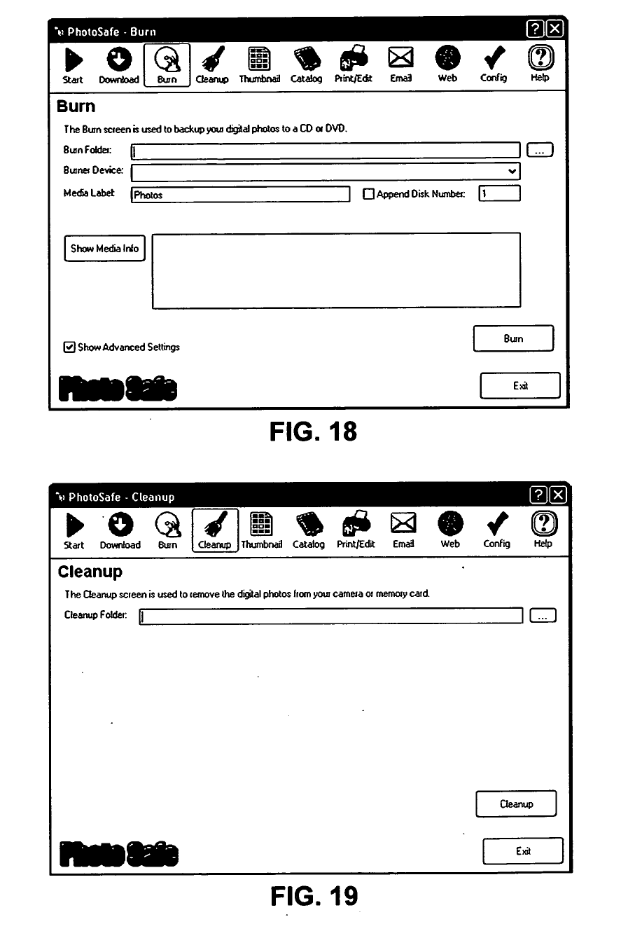

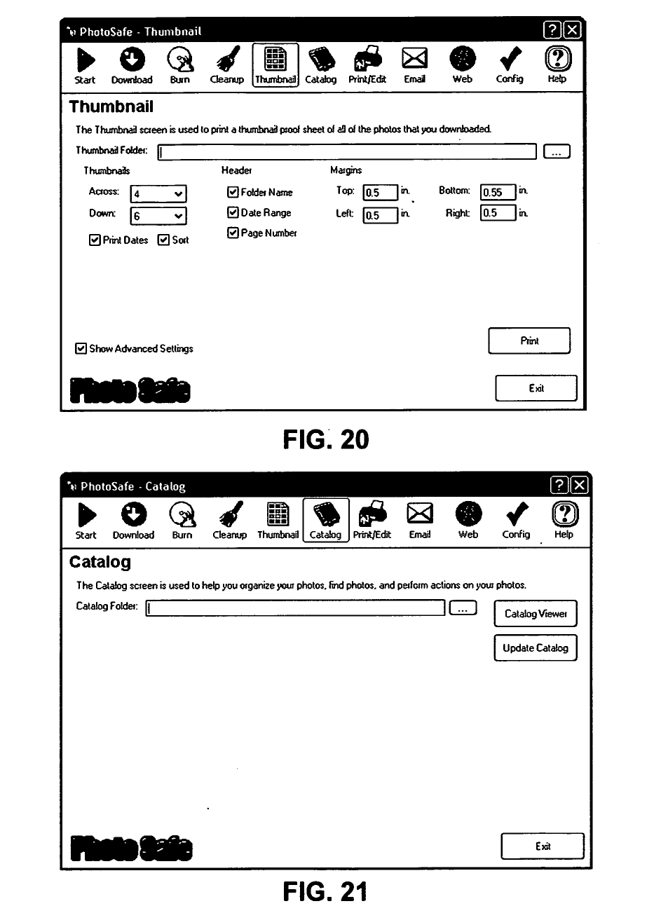

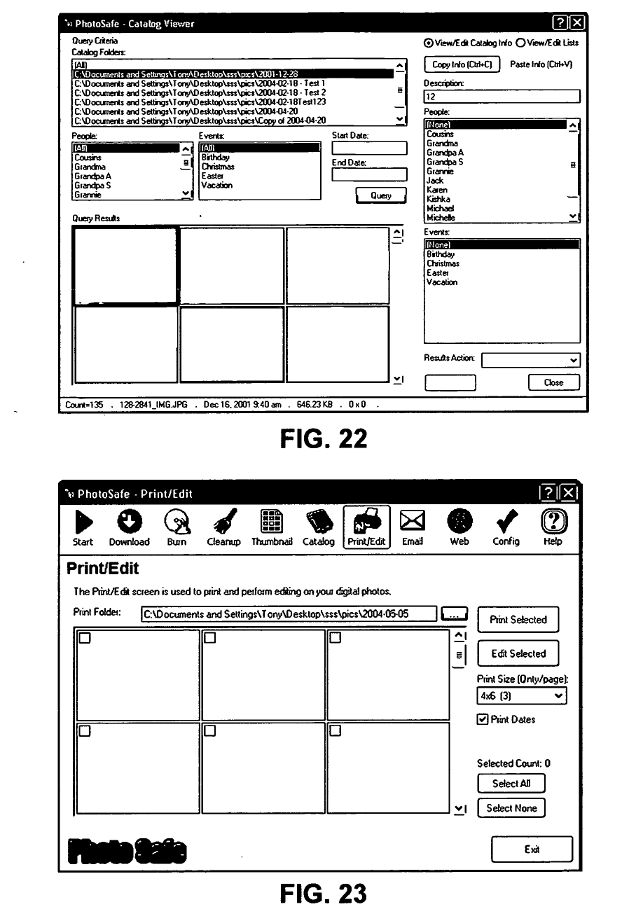

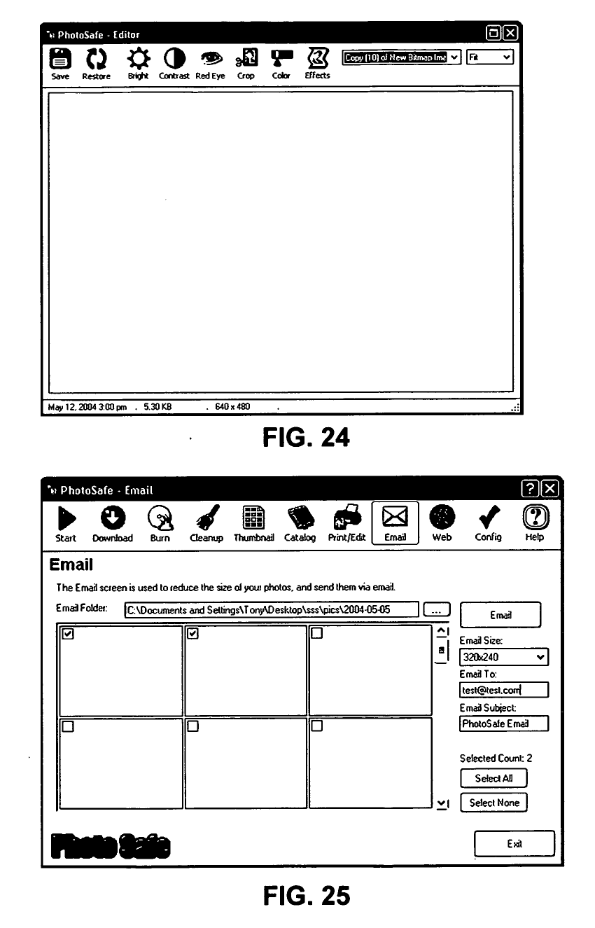

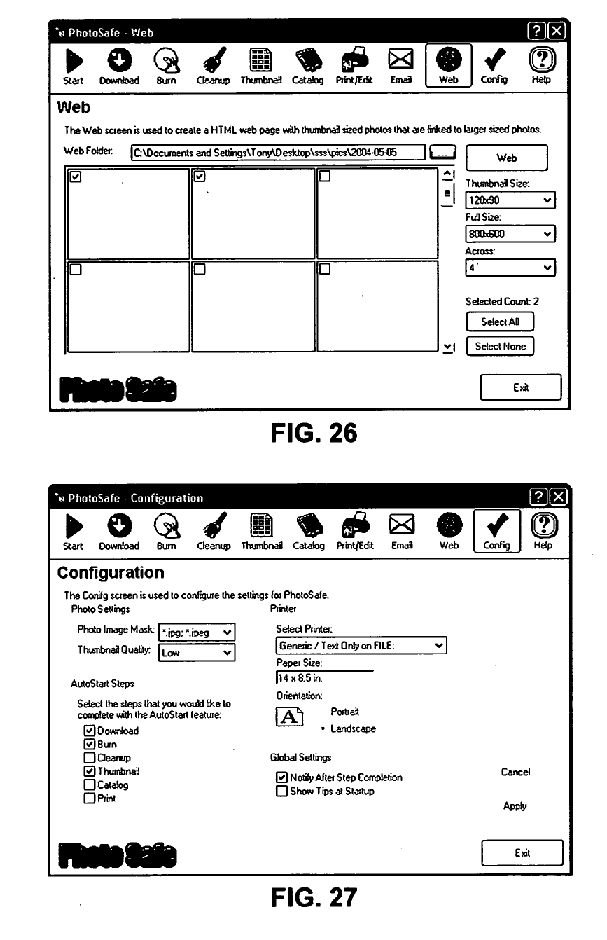

FIGS. 16-27 show screen displays for the various screen presented in this invention. FIG. 28 shows an example template used in step 904 of FIG. 14 to create the HTML web page for distributing images on the Internet. FIG. 29 shows what the example template, FIG. 28, would look like after completing the steps in FIG. 14.

1. A method for processing digital photography for digital cameras and other digital imaging devices, comprising of the steps required for digital photography processing.

2. A method of claim 1, wherein a single software application is used to perform all steps of digital photography processing.

3. A method of claim 2, wherein all digital photography processing steps are automatically completed with no user interaction required in said software application.

4. A method of claim 2, wherein intelligent default values are assigned for application settings in said software application.

5. A method of claim 2, wherein said software application is easy-to-use.

6. A method of claim 2, wherein saving changes to a digital photograph is automatically stored with a new filename to prevent overwriting master digital images in said software application.

7. A method of claim 2, wherein a central repository, like the Registry in Microsoft Windows operating systems, is used to store application settings for said software application.

8. A method of claim 2, wherein thumbnail previews are used to allow the user to select specific images for processing by presenting a 2 dimensional array of images with scrollbars to allow the user to easily find and select images in said software application.

9. A method of claim 3, wherein said software application automates the downloading of images from digital cameras or other digital imaging devices, and saves images on the disk drive in a folder structure that is easy to find and organize.

10. A method of claim 3, wherein said software application automates the backing up of master digital images to a CD, DVD, or other storage media in a manner that allows the user to organize the media with intelligent labels and an automatic media numbering system.

11. A method of claim 3, wherein said software application automates the cleanup process by deleting the images from cameras or other digital imaging devices, or formats the media within the camera or other digital imaging device.

12. A method of claim 3, wherein said software application automates the printing of thumbnail proof sheets to help the user visually organize and find photographs.

13. A method of claim 3, wherein said software application automates the photography printing process with advanced automatic photography processing techniques including features to adjust the contrast, exposure, brightness, red eye reduction, color and white balancing, centering, cropping, sharpness, and other parameters for each photograph automatically with no user intervention.

14. A method of claim 3, wherein said software application automates the distribution via email of digital photographs and reduces the size of the images while maintaining the aspect ratio.

15. A method of claim 3, wherein said software application automates the distribution via the Internet of digital photographs with the use of a HTML template and reduces the size of the images while maintaining the aspect ratio for both a thumbnail and full sized image for each photograph.

16. A method of claim 3, wherein said software application automates the cataloging of digital photographs by storing the filename, folder location, date, time, file size, image dimensions, and other information in a database.

17. A method of claim 16, wherein said software applications allows the user to quickly query the catalog database to find photographs based on descriptions, lists of people, lists of events, filename, folder location, date, time, file size, image dimensions, and other information.

18. A method of claim 17, wherein said software application allows the user to select actions to be performed on the photographs found by a query of the catalog database, including printing, backing up, emailing, Internet distribution, and copying to new folders on the disk drive.
